(19) United States
(12) Patent Application Publication
(10) Pub. No.: US 2026/0046881 A1
(43) Pub. Date: Feb. 12, 2026

(54) Dynamic Waveform Switching

(71) Applicant: Apple Inc., Cupertino, CA (US)

(72) Inventors: Chunhai YAO, Beijing (CN); Chunxuan YE, San Diego, CA (US); Dawei ZHANG, Saratoga, CA (US); Hong HE, San Jose, CA (US); Ankit BHAMRI, Haar (DE); Seyed Ali Akbar FAKOORIAN, San Diego, CA (US); Haitong SUN, Saratoga, CA (US); Wei ZENG, Saratoga, CA (US); Huaning NIU, San Jose, CA (US)

(21) Appl. No.: 19/103,033

(22) PCT Filed: Aug. 11, 2022
(86) PCT No.: PCT/CN2022/111859

§ 371 Date: Feb. 11, 2025

(51) Int. Cl. H04W 72/23; H04W 72/1268; H04W 74/0833

(52) U.S. Cl. CPC H04W 72/23; H04W 72/1268; H04W 74/0833

(57) ABSTRACT

Embodiments of the present disclosure relate to waveform indication and waveform switching. According to embodiments of the present disclosure, a baseband processor of user equipment (UE) is configured to perform operations comprising: receiving, using a transceiver of the UE, a waveform indication from a base station via layer 1 signaling or layer 2 signaling, the waveform indication indicating a target waveform, among a set of waveforms, to be used by the UE; and transmitting, using the transceiver of the UE, an uplink transmission to the base station based on the target waveform. In this way, dynamic waveform switching is achieved and coverage enhancement is provided.

### TECHNICAL FIELD

Embodiments of the present disclosure generally relate to the field of telecommunications, and in particular, to dynamic waveform switching.

### BACKGROUND

For new radio (NR) coverage, there are different types of waveforms for uplink communication including such as discrete fourier transform spread orthogonal frequency division multiplexing (DFT-S-OFDM) waveform and cyclic prefix orthogonal frequency division multiplexing (CP-OFDM) waveform. Each type of the waveforms has its advantages and disadvantages. Sometimes, there is a need to switch the uplink waveform from one type to another so as to accommodate the location of the user equipment (UE) or network scenario.

### SUMMARY

In general, example embodiments of the present disclosure provide a solution for dynamic waveform switching for uplink communication.

In a first aspect, there is provided a baseband processor of a user equipment. The baseband processor is configured to perform operations comprising: receiving, using a transceiver of the UE, a waveform indication from a base station via layer 1 signaling or layer 2 signaling, the waveform indication indicating a target waveform, among a set of waveforms, to be used by the UE; and transmitting, using the transceiver of the UE, an uplink transmission to the base station based on the target waveform.

In a second aspect, there is provided a user equipment. The user equipment comprises a transceiver and a baseband processor. The transceiver is configured to communicate with a network. The baseband processor is communicatively coupled to the transceiver and configured to perform operations comprising: receiving, using a transceiver of the UE, a waveform indication from a base station via layer 1 signaling or layer 2 signaling, the waveform indication indicating a target waveform, among a set of waveforms, to be used by the UE; and transmitting, using the transceiver of the UE, an uplink transmission to the base station based on the target waveform.

In a third aspect, there is provided a processor of a base station. The processor is configured to perform operations comprising: transmitting, using a transceiver of the BS, a signaling to indicate enabling/disabling dynamic waveform switching, a waveform indication to a UE via layer 1 signaling or layer 2 signaling, the waveform indication indicating a target waveform, among a set of waveforms, to be used by the UE; and receiving, using a transceiver of the BS, an uplink transmission from the UE based on the target waveform.

In a fourth aspect, there is provided a base station. The base station comprises a transceiver and a baseband processor. The transceiver is configured to communicate with a user equipment. The baseband processor is communicatively coupled to the transceiver and configured to perform operations comprising: transmitting, using a transceiver of the BS, a waveform indication to a UE via layer 1 signaling or layer 2 signaling, the waveform indication indicating a target waveform, among a set of waveforms, to be used by the UE; and receiving, using a transceiver of the BS, an uplink transmission from the UE based on the target waveform.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a signaling diagram illustrating a process for waveform indication and waveform switching according to some embodiments of the present disclosure;

FIG. 3 illustrates an exemplary PUSCH-Config IE for configurations of a waveform switching function indication of a base station according to some embodiments of the present disclosure;

FIG. 4 illustrates an exemplary RACH-ConfigCommon IE for configurations of a waveform switching function indication of a base station according to some other embodiments of the present disclosure;

FIG. 5 illustrates an exemplary ConfiguredGrantConfig IE for configurations of a waveform switching function indication of a base station according to still other embodiments of the present disclosure;

FIG. 6 illustrates an exemplary IE for configurations of a waveform indication via a TDRA table according to some embodiments of the present disclosure;

FIG. 7 illustrates an exemplary structure of a random access response grant content field according to some embodiments of the present disclosure;

FIG. 8 illustrates an exemplary structure of a media access control random access response according to some embodiments of the present disclosure;

FIG. 9 illustrates an exemplary structure of a fallback random access response according to some embodiments of the present disclosure;

FIG. 10 illustrates a flowchart illustrating an example method implemented at a UE in accordance with some embodiments of the present disclosure;

FIG. 11 illustrates a flowchart illustrating an example method implemented at a BS in accordance with some embodiments of the present disclosure; and

FIG. 12 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (4C), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. In the following description, the terms “network device”, “base station”, and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, there is a need to switch the uplink waveform from one type to another so as to accommodate the location of the UE or network scenario. For example, when a UE moves from the cell center to the cell edge, the uplink waveform needs to be switched from CP-OFDM to DFT-S-OFDM, since DFT-S-OFDM has low peak to average power ratio (PAPR) and is beneficial for uplink coverage limited scenario. Furthermore, for coverage enhancement, it requires performing the waveform switching in a fast and dynamic manner so as to ensure discontinued coverage.

In current technology, uplink waveform is configured via radio resource control (RRC) signaling, which is quite slow and called as semi-static waveform switching. This limitation imposes a large barrier to switch over to DFT-S-OFDM waveform for cell-edge UEs practically. The current waveform configuration is shown in the text box below.

6.1.3 UE procedure for applying transform precoding on PUSCH

For Msg3 PUSCH transmission, the UE shall consider the transform precoding either
‘enabled’ or ‘disabled’ according to the higher layer configured parameter
msg3-transformPrecoder.
For PUSCH transmission scheduled by a PDCCH with CRC scrambled by CS-RNTI with
NDI = 1, C-RNTI, or MCS-C-RNTI or SP-CSI-RNTI:
If the DCI with the scheduling grant was received with DCI format 0_0, the UE shall,
for this PUSCH transmission, consider the transform precoding either enabled or
disabled according to the higher layer configured parameter msg3-transformPrecoder.
If the DCI with the scheduling grant was not received with DCI format 0_0
If the UE is configured with the higher layer parameter transformPrecoder in
pusch-Config, the UE shall, for this PUSCH transmission, consider the transform
precoding either enabled or disabled according to this parameter.
If the UE is not configured with the higher layer parameter transformPrecoder in
pusch-Config, the UE shall, for this PUSCH transmission, consider the transform
precoding either enabled or disabled according to the higher layer configured
parameter msg3-transformPrecoder.
For PUSCH transmission with a configured grant
If the UE is configured with the higher layer parameter transformPrecoder in
configuredGrantConfig, the UE shall, for this PUSCH transmission, consider the
transform precoding either enabled or disabled according to this parameter.
If the UE is not configured with the higher layer parameter transformPrecoder in
configuredGrantConfig, the UE shall, for this PUSCH transmission, consider the
transform precoding either enabled or disabled according to the higher layer configured
parameter msg3-transformPrecoder.

Release 18 (R18) has included an objective for dynamic switching between DFT-S-OFDM and CP-OFDM. However, no specific configuration has been defined for the dynamic waveform switching. For dynamic waveform switching, the following issues need to be solved, including configuration of the dynamic waveform switching, solution for dynamic waveform switching for dynamic scheduled physical uplink shared channel (PUSCH), solution for dynamic waveform switching for Msg3/MsgA PUSCH initial transmission and solution for dynamic waveform switching for re-transmission and solution for configured grant PUSCH.

Embodiments of the present disclosure propose a solution for dynamic waveform switching for the above mentioned scenarios. In this solution, the BS transmits a waveform indication to the UE via layer 1 signaling or layer 2 signaling, the waveform indication indicating a target waveform, among a set of waveforms, to be used by the UE. Then, the UE transmits an uplink transmission to the base station based on the target waveform.

According to embodiments of the present disclosure, by transmitting the waveform indication via layer 1 signaling or layer 2 signaling, the waveform indication could be received by UE very quickly. Thus, UE can switch to the target waveform indicated by the waveform indication very fast, so as to achieve dynamic waveform switching and ensure UE is always under the coverage of the BS.

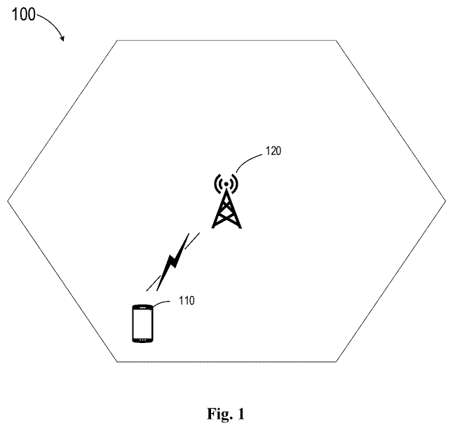

Principle and implementations of the present disclosure will be described in detail below with reference to FIGS. 1-12. FIG. 1 shows an example communication network 100 in which embodiments of the present disclosure can be implemented. The network 100 includes a user equipment (UE) 110 and base station (BS) 120 served by the BS 120. The network 100 may provide one or more serving cells to serve the UE 110.

It is to be understood that the number of UE(s) 110 and BS(s) 120 is only for the purpose of illustration without suggesting any limitations. The network 100 may include any suitable number of BSs, UEs and serving cells adapted for implementing embodiments of the present disclosure.

In the communication network 100, the BS 120 can communicate data and control information to the UE 110 and the UE 110 can also communication data and control information to the BS 120. A link from the BS 120 to the UE 110 is referred to as a downlink (DL) or a forward link, while a link from the UE 110 to the BS 120 is referred to as an uplink (UL) or a reverse link.

In the communication network 100, the UE 110 can transmit uplink communication based on a set of waveforms. In some embodiments, the set of waveforms includes a DFT-S-OFDM waveform and a CP-OFDM waveform. Although there are only two types of waveforms are exemplified, those skilled in the art could understand the set of waveforms could include other types of waveform, not restricted to the two types mentioned.

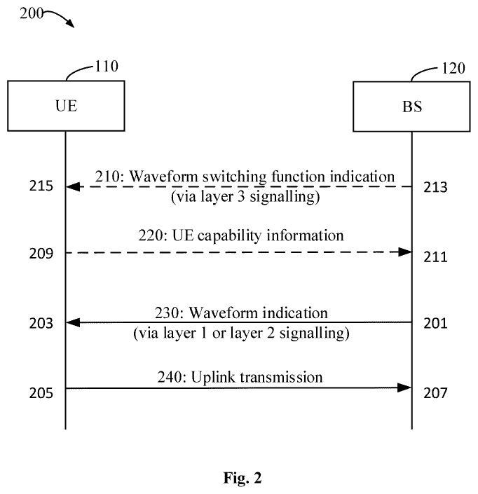

FIG. 2 illustrates a signaling diagram illustrating a process for waveform indication and waveform switching according to some embodiments of the present disclosure. For the purpose of discussion, the process 200 will be described with reference to FIG. 1. The process 200 may involve the UE 110 and the BS 120 in FIG. 1.

The BS 120 transmits 201 a waveform indication 230 to the UE 110 via layer 1 signaling or layer 2 signaling. The waveform indication 230 indicates a target waveform, among a set of waveforms, to be used by the UE 110. Accordingly, the UE 110 receives 203 the waveform indication 230 from the BS 120 via the layer 1 signaling or the layer 2 signaling. Then, the UE 110 transmits 205 an uplink transmission 240 to the base station 120 based on the target waveform. On the other side of the communication, the BS 120 receives 207 the uplink transmission 240 from the UE 110.

With the process 200, since the target waveform of the uplink transmission 240 may be indicated by the BS 120 to the UE 110 via the layer 1 signaling or the layer 2 signaling, the target waveform to be used by the UE 110 to transmit the uplink transmission 240 can be dynamically controlled and switched by the BS 120. In this way, dynamic switching among the set of waveforms for uplink transmissions from the UE 110 to the BS 120 can be achieved, thereby providing coverage enhancement and improving the performance of communications between the UE 110 and the BS 120.

In some embodiments, the target waveform is determined and configured by the BS in the waveform indication. In some embodiments, the layer 1 signaling includes physical layer signaling comprising downlink control information (DCI). In some embodiments, the layer 2 signaling includes medium access control (MAC) signaling comprising medium access control (MAC) control elements (CEs).

In some embodiments, the waveform indication indicates whether the DFT-S-OFDM waveform or the CP-OFDM waveform is to be used through indicating whether a transform precoder is enabled or disabled. If the waveform indication indicates the transform precoder is enables, the DFT-S-OFDM waveform is to be used by uplink transmission. Otherwise, if the waveform indication indicates the transform precoder is disabled, the CP-OFDM waveform is to be used by uplink transmission.

In some embodiments, prior to the BS 120 transmits 201 the waveform indication 230 to the UE 110, the UE 110 may transmit 209, to the base station 120, UE capability information 220 indicating whether the UE 110 supports switching among the set of waveforms, so as to tell BS 120 whether UE 110 is capable of waveform switching. On the other side of the communication, the BS 120 receives 209 the UE capability information 220 from the UE 110. By this means, the BS 120 could only transmit waveform indication to the UE 110 which is capable of waveform switching, thus unnecessary waveform indication transmission to the UE 110 which does not support waveform switching could be avoided.

In some embodiments, prior to the BS 120 transmits 201 the waveform indication 230 to the UE 110, the BS 120 may first transmit 213, to the UE 110, layer 3 signaling 210 indicating whether switching among the set of waveforms function of BS 120 is enabled or disabled. On the other side of the communication, the BS 120 receives 215 the layer 3 signaling 210 from the UE 110. By this means, the waveform switching could be performed only when the waveform switching function of the BS 120 is enabled, so as to further reduce unnecessary operations and transmissions.

In some embodiments, the layer 3 signaling includes a RRC signaling. For example, the BS 120 may configure an information element (IE), such as dynamicTransformPrecoder, in the layer 3 signaling to indicate whether the waveform switching function of the BS 120 is enabled. If the IE dynamicTransformPrecoder is set to ‘one’, it means enabling the waveform switching function of the BS 120. If the IE dynamicTransformPrecoder is set to ‘zero’, it means disabling the waveform switching function of the BS 120.

Under the first scenario of a dynamic scheduled PUSCH, the layer 3 signaling may be specific to a UE 110. In this scenario, the waveform switching function indication of the BS 120 may be included in a PUSCH-Config information element.

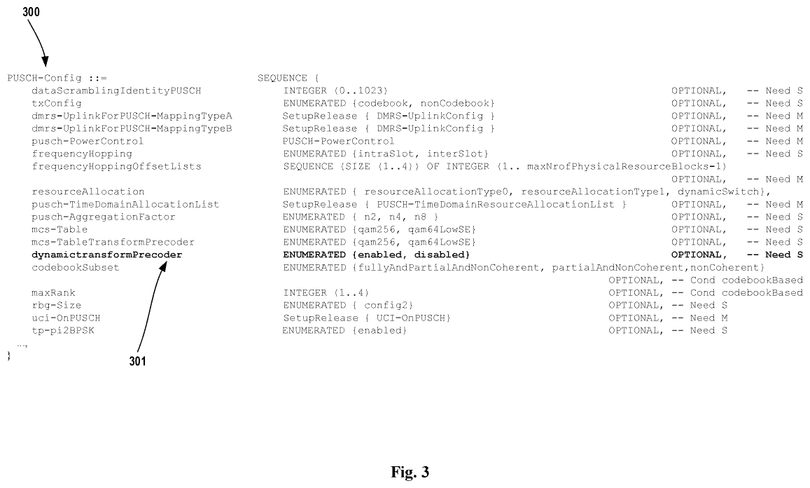

FIG. 3 illustrates an exemplary PUSCH-Config IE for configurations of a waveform switching function indication of a base station according to some other embodiments of the present disclosure.

As can be seen, an IE such as dynamicTransformPrecoder is introduced into the PUSCH-Config information element. IE dynamicTransformPrecoder indicates whether the waveform switching function of the BS is enabled. The IE dynamicTransformPrecoder in the PUSCH-Config information element may be applied to PUSCH scheduled by DCI format 0_1 or DCI format 0_2.

Under the second scenario of a Msg3 PUSCH initial transmission or retransmission, the layer 3 signaling may be specific to a cell in which the UE is located. In this scenario, the waveform switching function indication of the base station may be included in a RACH-ConfigCommon information element.

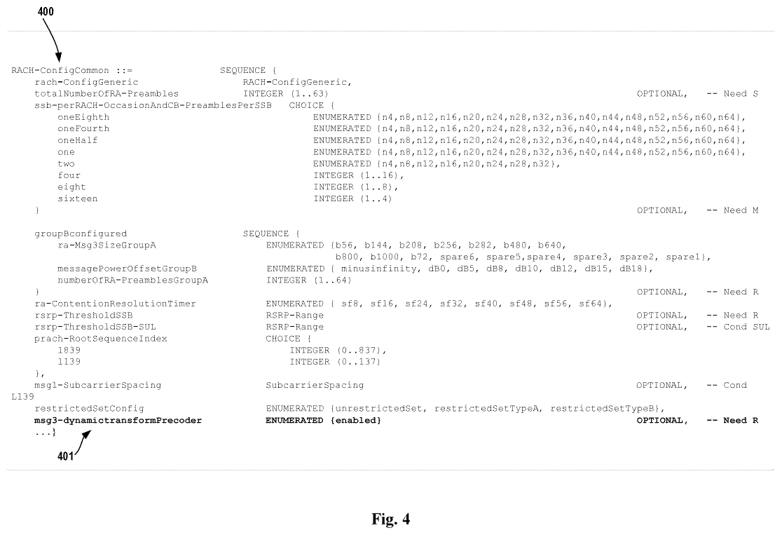

FIG. 4 illustrates an exemplary RACH-ConfigCommon IE for configurations of a waveform switching function indication of a base station according to some embodiments of the present disclosure.

As can be seen, an IE such as msg3-dynamicTransformPrecoder is introduced into the RACH-ConfigCommon information element. IE msg3-dynamicTransformPrecoder indicates whether the waveform switching function of the BS is enabled specific to the cell that the BS supports. If the IE msg3-dynamicTransformPrecoder is set to ‘one’, it means enabling the waveform switching function of the BS. If the IE dynamicTransformPrecoder is set to ‘zero’, it means disabling the waveform switching function of the BS. The IE msg3-dynamicTransformPrecoder may be applied to DCI format 0_0. The IE msg3-dynamicTransformPrecoder may also be applied to PUSCH scheduled by random access response (RAR) uplink grant, or PUSCH scheduled by fallback RAR uplink grant, or PUSCH scheduled by DCI format 0_0 with cyclic redundancy check (CRC) scrambled by temporary Cell RadioNetworkTemporaryIdentifier (TC-RNTI).

Under the third scenario of a configured grant PUSCH, the waveform switching function indication of the base station may be included in a ConfiguredGrantConfig information element.

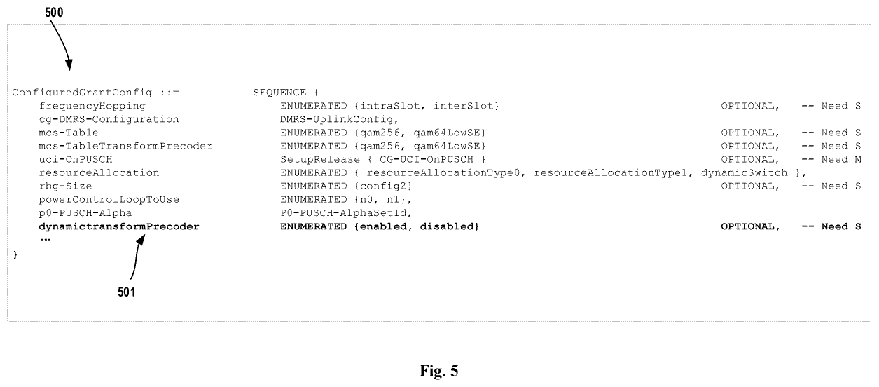

FIG. 5 illustrates an exemplary IE for configurations of a waveform switching function indication of a base station according to still other embodiments of the present disclosure.

As can be seen, an IE such as dynamicTransformPrecoder is introduced into the ConfiguredGrantConfig information element. IE dynamicTransformPrecoder indicates whether the waveform switching function of the BS is enabled.

In some embodiments, the UE may transmit a UE capability information indicating whether the UE supports switching among the set of waveforms to the base station. In some embodiments, the UE may transmits the UE capability information for at least one of scenarios including Msg3 PUSCH initial transmission or retransmission, dynamic scheduled PUSCH, and configured grant PUSCH.

If the waveform switching function of the BS is enabled by layer 3 signalling and the UE supports waveform switching, the BS may transmit the waveform indication to UE via layer 1 signaling or layer 2 signaling.

Under the first scenario, the uplink transmission is a dynamic scheduled PUSCH, the waveform indication could be transmitted via DCI in the layer 1 signalling or MAC CE in the layer 2 signalling.

In one embodiment, a one-bit new field in the DCI could be used to indicate the target waveform, such as the DFT-S-OFDM or CP-OFDM. For example, a one-bit new field can be an IE transformPrecoder. The IE transformPrecoder indicates whether the transform precoder is enabled. If the IE transformPrecoder has a value of ‘one’, it means transform precoder is enabled, i.e., DFT-S-OFDM waveform is to be used. If the IE transformPrecoder has a value of ‘zero’, it means transform precoder is disabled, i.e., CP-OFDM waveform is to be used.

Alternatively or additionally, a bit in an existing field of the DCI could be reinterpreted to indicate the target waveform. For example, a bit in the redundancy version field of the DCI could be used to indicate the target waveform. Alternatively or additionally, a new information element in a time domain resource allocation (TDRA) table of the DCI could be used to indicate the target waveform. In this manner, the waveform indication field would not much affect the structure of the DCI.

FIG. 6 illustrates an exemplary IE for configurations of a waveform indication via a TDRA table according to some embodiments of the present disclosure. As can be seen, a transformPrecoder IE may be introduced as part of PUSCH-TimeDomainResourceAllocationlist in PUSCH-Config information element to indicate the target waveform.

Alternatively or additionally, a MAC CE may be used to indicate the target waveform. A new MAC CE may be introduced to indicate the target waveform. A existing MAC CE may be reinterpreted to indicate the target waveform.

Under the second scenario, the uplink transmission is a Msg3 PUSCH initial transmission and re-transmission, the waveform indication could be transmitted via DCI in the layer 1 signalling or MAC CE in the layer 2 signalling.

In this scenario, UE may trigger the waveform switching process. UE may select a dedicated physical random access channel (PRACH) preamble in a shared PRACH occasion or separate configured PRACH occasion reserved by the base station. Afterward, UE may transmit the selected dedicated PRACH preamble to the base station. If the reserved dedicated PRACH preamble is detected by the base station, the base station would know the UE has the capability of waveform switching. That is to say, a UE capability information indicating whether the UE supports waveform switching among the set of waveforms is implicitly informed to the base station via the dedicated PRACH preamble being detected by the base station.

In some embodiments, after the BS gets to know that the UE supports waveform switching, the BS may determine which waveform of the set of waveforms will be applied, and transmit waveform indication indicating the determined waveform to the UE. In some embodiments, UE may trigger the waveform switching process by transmitting a request for switching waveform to the BS. The request for switching waveform may be transmitted based on a comparison measurement result between a reference signal receiving power (RSRP) of downlink communication and a predetermined threshold. If the RSRP is lower than the predetermined threshold, the UE may have the risk of being uncovered by the cell supported by the BS. At this time, the UE may transmit a request for switching to a waveform beneficial for uplink coverage limited scenario, such as the DFT-S-OFDM waveform, to the BS. When the UE moves to the edge of the cell or has some problems in connecting with the BS, UE will be uncovered by the cell supported by the BS.

In one embodiment, the waveform indication may be transmitted via a bit of random access response (RAR) grant message. An information field from the existing information fields in RAR grant message could be used for waveform indication. By this means, the total size of RAR grant message does not change, and the structure of MAC RAR does not change either.

In some embodiments, the waveform indication may be transmitted via a bit related to a TDRA table of the RAR grant message. In such embodiments, an information element in a new TDRA table may be used for the waveform indication. The new TDRA table may take use of bits from other information fields of the RAR grant message. The new TDRA table may be configured by a system information block (SIB), such as SIB1, SIB2, etc. The new TDRA table includes information fields from legacy TDRA table and a new field for waveform indication. The information fields from legacy TDRA table may include a K2 field, a mappingType field and a startSymbolAndLength field. The new field for waveform indication may be a msg3-transformPrecoder field.

Alternatively or additionally, a bit in an existing field of an existing TDRA table of the DCI scheduling the Msg3 PUSCH initial transmission and re-transmission may be reinterpreted for the waveform indication. Alternatively or additionally, a one-bit added into the existing TDRA table may be used for the waveform indication. The one-bit added may be taken from other information fields outside the TDRA table of the RAR grant message, such as the channel state information (CSI) request field. In this manner, it could ensure flexibility to configure time domain resources for the UE since the previous existing information fields in TDRA table remain unchanged.

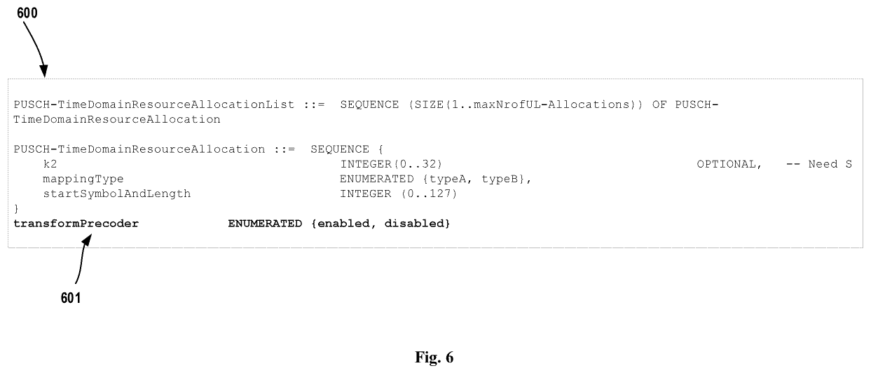

In some other embodiments, the waveform indication may be transmitted via a bit in an existing field unrelated to the TDRA table of the RAR grant message. FIG. 7 illustrates an exemplary structure of RAR grant field according to some embodiments of the present disclosure. As can be seen, the RAR grand field includes several information fields unrelated to the TDRA table.

In such embodiments, a bit of a modulation and coding scheme (MCS) information field of the RAR grant may be used for waveform indication. For example, the most significant bit (MSB) bit could be used for waveform indication.

Alternatively or additionally, a bit of a transmission power control (TPC) information field of the RAR grant may be used for waveform indication. For example, the least significant bit (LSB) bit could be used for waveform indication. For another example, the TPC command table may be redefined and the waveform indication is included.

Alternatively or additionally, a bit of a channel state information (CSI) request information field may be used for waveform indication.

Alternatively or additionally, a bit of a PUSCH frequency resource allocation information field may be used for waveform indication. Since the size of the msg3 PUSCH is not so large, the PUSCH frequency resource allocation information field may have bits unused. Therefore, the PUSCH frequency resource allocation information field could be truncated to make one bit available for waveform indication.

In another embodiment, the waveform indication may be transmitted via a reinterpreted bit in hybrid automatic repeat request (HARQ) process number field. For example, for Msg3 retransmission, the information fields in DCI format 0_0 with CRC scrambled by TC-RNTI maybe reinterpreted for waveform indication. Specifically, the HARQ process number field in DCI format 0_0 with CRC scrambled by TC-RNTI may be reinterpreted for the waveform indication.

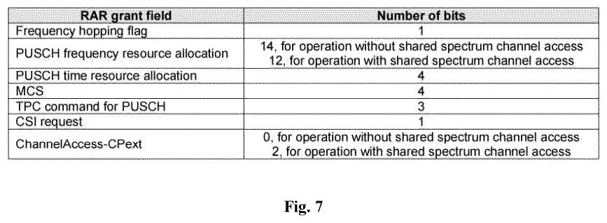

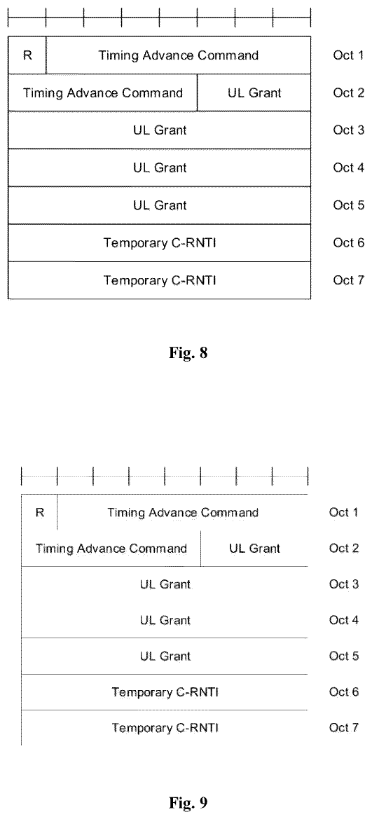

In still other embodiment, for Msg3 PUSCH initial transmission and re-transmission, the waveform indication may be transmitted via a MAC CE. FIG. 8 illustrates an exemplary structure of media access control random access response according to some embodiments of the present disclosure. The reserved R bit of the MAC RAR control element may be used for waveform indication.

Under the scenario of a MsgA physical uplink shared channel (PUSCH) initial transmission or retransmission, the waveform indication can be transmitted similar as the above disclosure as for the scenario of the Msg3 physical uplink shared channel (PUSCH) initial transmission or retransmission. For example, an information element in a new TDRA table may be used for the waveform indication. Alternatively or additionally, a bit in an existing field of an existing TDRA table of the MsgA PUSCH initial transmission and re-transmission may be reinterpreted for the waveform indication. Still alternatively or additionally, one-bit added into the existing TDRA table may be used for the waveform indication.

In such scenario, for MsgA PUSCH re-transmission, the waveform indication may be transmitted via a MAC CE. FIG. 9 illustrates an exemplary structure of fallback random access response according to some embodiments of the present disclosure. The reserved R bit of the fallback MAC RAR control element may be used for waveform indication.

Under the third scenario, the uplink transmission is a configured grant PUSCH, the waveform indication could be transmitted via DCI in the layer 1 signalling.

In this scenario, the waveform indication may be transmitted via a one-bit field in a TDRA table field of a DCI scheduling the configured grant PUSCH, such as the Type 1 configured grant PUSCH. Alternatively or additionally, the waveform indication may be transmitted via a reinterpreted bit in an existing field of the DCI scheduling the configured grant PUSCH. Alternatively or additionally, the waveform indication may be transmitted via a new field introduced in timeDomainResourceAllocation IE of ConfiguredGrantConfig IE for the configured grant PUSCH, such as Type 1 and Type 2 configured grant PUSCH.

In some embodiments, the target waveform indicated by the waveform indication for the Msg3 or MsgA retransmission may be same as the target waveform indicated by the waveform indication for the Msg3 or MsgA initial transmission. For example, if the waveform indication for the Msg3 or MsgA initial transmission indicates the DFT-S-OFDM waveform is to be used, the waveform indication for the Msg3 or MsgA retransmission may also indicate the DFT-S-OFDM is to be used. Alternatively or additionally, the target waveform indicated by the waveform indication for the Msg3 or MsgA retransmission may be different as the target waveform indicated by the waveform indication for the Msg3 or MsgA initial transmission.

In some embodiments, the uplink transmission is a small data transmission (SDT) and the above waveform indication means also apply for the SDT. Specifically, as for random access based SDT, the waveform indication means for Msg3 and MsgA initial transmission and retransmission can be used for waveform switching. As for configured grant based SDT, the waveform indication means for configured grant PUSCH can be used for waveform switching.

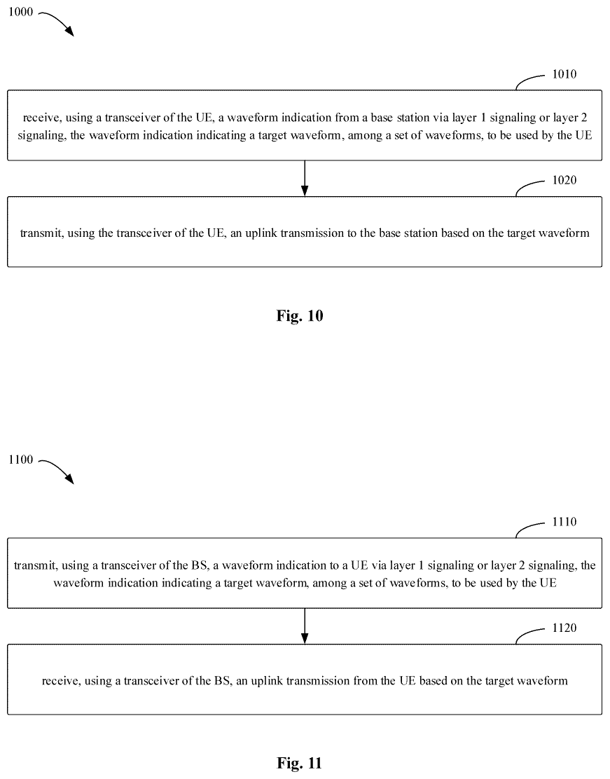

FIG. 10 illustrates a flowchart illustrating an example method 1000 for waveform indication implemented at a UE in accordance with some embodiments of the present disclosure. The method 1000 can be implemented at a device, for example the UE 110 shown in FIG. 1. It is to be understood that the method 1000 may include additional blocks not shown and/or may omit some shown blocks, and the scope of the present disclosure is not limited in this regard.

At block 1010, the UE 110 receives, using a transceiver of the UE 110, a waveform indication from a base station 120 via layer 1 signaling or layer 2 signaling, the waveform indication indicating a target waveform, among a set of waveforms, to be used by the UE 110. At block 1020, the UE 110 transmits, using the transceiver of the UE 110, an uplink transmission to the base station 120 based on the target waveform.

In some embodiments, prior to receiving the layer 1 signaling or the layer 2 signaling, the UE 110 receives, using the transceiver of the UE 110, from the base station 120, layer 3 signaling indicating whether switching among the set of waveforms is enabled or disabled. In some embodiments, the layer 3 signaling is specific to a cell in which the UE 110 is located. In some embodiments, the layer 3 signaling is for a Msg3 physical uplink shared channel (PUSCH) initial transmission or retransmission.

In some embodiments, the layer 3 signaling is specific to the UE 110. In some embodiments, the layer 3 signaling is for a dynamic scheduled PUSCH. In some embodiments, the layer 3 signaling is for a configured grant PUSCH.

In some embodiments, at least one of the following is satisfied: the layer 1 signaling comprises downlink control information (DCI); and the layer 2 signaling comprises a medium access control (MAC) control element (CE). In some embodiments, the UE 110 transmits, using the transceiver of the UE 110 to the base station, UE capability information indicating whether the UE 110 supports switching among the set of waveforms.

In some embodiments, the set of waveforms include a discrete Fourier transform spread orthogonal frequency division multiplexing (DFT-S-OFDM) waveform and a cyclic prefix orthogonal frequency division multiplexing (CP-OFDM) waveform. In some embodiments, the waveform indication indicates whether the DFT-S-OFDM waveform or the CP-OFDM waveform is to be used through indicating whether a transform precoder is enabled or disabled.

In some embodiments, the uplink transmission is a dynamic scheduled PUSCH. In some embodiments, the set of waveforms include two waveforms and the waveform indication is received via at least one of the following: a one-bit field in a DCI scheduling the dynamic scheduled PUSCH; a reinterpreted bit in an existing field of the DCI; an information element in a time domain resource allocation (TDRA) table of the DCI; and a MAC CE.

In some embodiments, the uplink transmission is a Msg3 PUSCH initial transmission and re-transmission. In some embodiments, the UE 110 selects a dedicated physical random access channel (PRACH) preamble in a shared PRACH occasion or separate configured PRACH occasion reserved by the base station 120, and transmits, using the transceiver of the UE 110 to the base station 120, the selected dedicated PRACH preamble, wherein a UE capability information indicating whether the UE 110 supports switching among the set of waveforms is implicitly informed to the base station 120 via the dedicated PRACH preamble being detected by the base station 120.

In some embodiments, the UE 110 transmits, using the transceiver of the UE 110 to the base station 120, a request for switching waveform, based on a comparison measurement result between a reference signal receiving power (RSRP) of downlink communication and a predetermined threshold.

In some embodiments, the set of waveforms include two waveforms and the waveform indication is received via at least one of the following: a bit of random access response (RAR) grant message; a reinterpreted bit in hybrid automatic repeat request (HARQ) process number field; and a reserved bit in MAC random access response (RAR) control element.

In some embodiments, the bit of RAR grant message is at least one of the following: a bit related to a time domain resource allocation (TDRA) table; a bit of a modulation and coding scheme (MCS) information field; a bit of a transmission power control (TPC) information field; a bit of a channel state information (CSI) request information field; and a bit of a PUSCH frequency resource allocation information field.

In some embodiments, the bit related to the TDRA table is at least one of the following: an information element in a new TDRA table; and a reinterpreted bit in an existing field of an existing TDRA table of a DCI scheduling the Msg3 PUSCH initial transmission and re-transmission; and a one-bit added from the CSI request field information into the existing TDRA table.

In some embodiments, the uplink transmission is a MsgA PUSCH initial transmission and re-transmission. In some embodiments, the set of waveforms include two waveforms and the waveform indication is received via at least one of the following: an information element in a new TDRA table; and a reinterpreted bit in an existing field of an existing TDRA table of the MsgA PUSCH initial transmission and re-transmission; an one-bit added from the CSI request field information into the existing TDRA table; and one reserved bit of fallback MAC RAR control element.

In some embodiments, the uplink transmission is a configured grant PUSCH. In some embodiments, the set of waveforms include two waveforms and the waveform indication is received via at least one of the following: a one-bit field in a TDRA table of a DCI scheduling the configured grant PUSCH; a reinterpreted bit in an existing field of the DCI. In some embodiments, the uplink transmission is a small data transmission (SDT); and a new field in timeDomainResourceAllocation IE of ConfiguredGrantConfig IE.

FIG. 11 illustrates a flowchart illustrating an example method 1100 for waveform indication implemented at a BS in accordance with some embodiments of the present disclosure. The method 1100 can be implemented at a device, for example, the BS 120 shown in FIG. 1. It is to be understood that the method 1100 may include additional blocks not shown and/or may omit some shown blocks, and the scope of the present disclosure is not limited in this regard.

At block 1110, the BS 120 transmits, using a transceiver of the BS 120, a waveform indication to a UE 110 via layer 1 signaling or layer 2 signaling, the waveform indication indicating a target waveform, among a set of waveforms, to be used by the UE 110. At block 1120, the BS 120 receives, using a transceiver of the BS 120, an uplink transmission from the UE 110 based on the target waveform.

In some embodiments, prior to transmitting the layer 1 signaling or the layer 2 signaling, the BS 120 transmits, using the transceiver of the BS 120 to the UE 110, layer 3 signaling indicating whether switching among the set of waveforms is enabled or disabled. In some embodiments, the layer 3 signaling is specific to a cell in which the UE 110 is located.

In some embodiments, the layer 3 signaling is for a Msg3 physical uplink shared channel (PUSCH) initial transmission or retransmission. In some embodiments, the layer 3 signaling is specific to the UE 110. In some embodiments, the layer 3 signaling is for a dynamic scheduled PUSCH. In some embodiments, the layer 3 signaling is for a configured grant PUSCH.

In some embodiments, at least one of the following is satisfied: the layer 1 signaling comprises downlink control information (DCI); and the layer 2 signaling comprises a medium access control (MAC) control element (CE). In some embodiments, the BS 120 receives, using the transceiver of the BS 120 from the UE 110, UE capability information indicating whether the UE 110 supports switching among the set of waveforms.

In some embodiments, the set of waveforms include a discrete Fourier transform spread orthogonal frequency division multiplexing (DFT-S-OFDM) waveform and a cyclic prefix orthogonal frequency division multiplexing (CP-OFDM) waveform. In some embodiments, the waveform indication indicates whether the DFT-S-OFDM waveform or the CP-OFDM waveform is to be used through indicating whether a transform precoder is enabled or disabled

In some embodiments, the uplink transmission is a dynamic scheduled PUSCH. In some embodiments, the set of waveforms include two waveforms and the waveform indication is received via at least one of the following: a one-bit field in a DCI scheduling the dynamic scheduled PUSCH; a reinterpreted bit in an existing field of the DCI; an information element in a time domain resource allocation (TDRA) table of the DCI; and a MAC CE.

In some embodiments, the uplink transmission is a Msg3 PUSCH initial transmission and re-transmission. In some embodiments, the BS 120 receives, using the transceiver of the BS 120 from the UE 110, a dedicated PRACH preamble in a shared PRACH occasion or separate configured PRACH occasion selected by the UE 110, wherein a UE capability information indicating whether the UE 110 supports switching among the set of waveforms is implicitly informed to the base station via the dedicated PRACH preamble being detected by the BS 120.

In some embodiments, the BS 120 receives, using the transceiver of the BS 120 from the UE 110, a request for switching waveform, based on a comparison measurement result between a reference signal receiving power (RSRP) of downlink communication and a predetermined threshold.

In some embodiments, the set of waveforms include two waveforms and the waveform indication is received via at least one of the following: a bit of random access response (RAR) grant message; a reinterpreted bit in hybrid automatic repeat request (HARQ) process number field; and a reserved bit in MAC random access response (RAR) control element.

In some embodiments, the bit of RAR grant message is at least one of the following: a bit related to a time domain resource allocation (TDRA) table; a bit of a modulation and coding scheme (MCS) information field; a bit of a transmission power control (TPC) information field; a bit of a channel state information (CSI) request information field; and a bit of a PUSCH frequency resource allocation information field.

In some embodiments, the bit related to the TDRA table is at least one of the following: an information element in a new TDRA table; and a reinterpreted bit in an existing field of an existing TDRA table of a DCI scheduling the Msg3 PUSCH initial transmission and re-transmission; and a one-bit added from the CSI request field information into the existing TDRA table.

In some embodiments, the uplink transmission is a MsgA PUSCH initial transmission and re-transmission. In some embodiments, the set of waveforms include two waveforms and the waveform indication is received via at least one of the following: an information element in a new TDRA table; and a reinterpreted bit in an existing field of an existing TDRA table of the MsgA PUSCH initial transmission and re-transmission; an one-bit added from the CSI request field information into the existing TDRA table; and one reserved bit of fallback MAC RAR control element.

In some embodiments, the uplink transmission is a configured grant PUSCH. In some embodiments, the set of waveforms include two waveforms and the waveform indication is received via at least one of the following: a one-bit field in a TDRA table of a DCI scheduling the configured grant PUSCH; a reinterpreted bit in an existing field of the DCI. In some embodiments, the uplink transmission is a small data transmission (SDT); and a new field in timeDomainResourceAllocation IE of ConfiguredGrantConfig IE.

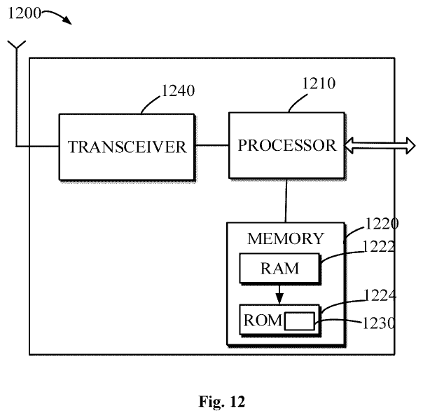

FIG. 12 is a simplified block diagram of a device 1200 that is suitable for implementing embodiments of the present disclosure. For example, the UE 110 and the BS 120 can be implemented by the device 1200. As shown, the device 1200 includes a processor 1210, a memory 1220 coupled to the processor 1210, and a transceiver 1240 coupled to the processor 1210.

The transceiver 1240 is for bidirectional communications. The transceiver 1240 is coupled to at least one antenna to facilitate communication. The transceiver 1240 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 1210 may be of any type suitable to the local technical network and may include one or more of the following: baseband processors, general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1230 so that the device 1200 may perform any process of the disclosure as discussed with reference to FIGS. 2-11. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 1000 as described above with reference to FIG. 10 and/or the method 1100 as described above with reference to FIG. 11.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A baseband processor of user equipment (UE) configured to perform operations comprising:
receiving, using a transceiver of the UE, a waveform indication from a base station via layer 1 signaling or layer 2 signaling, the waveform indication indicating a target waveform, among a set of waveforms, to be used by the UE; and
transmitting, using the transceiver of the UE, an uplink transmission to the base station based on the target waveform.

2. The baseband processor of claim 1, wherein the operations further comprise:
prior to receiving the layer 1 signaling or the layer 2 signaling, receiving, using the transceiver of the UE, from the base station, layer 3 signaling indicating whether switching among the set of waveforms is enabled or disabled.

3. The baseband processor of claim 2, wherein the layer 3 signaling is specific to a cell in which the UE is located.

4. The baseband processor of claim 3, wherein the layer 3 signaling is for a Msg3 physical uplink shared channel (PUSCH) initial transmission or retransmission.

5. The baseband processor of claim 2, wherein the layer 3 signaling is specific to the UE.

6. (canceled)

7. The baseband processor of claim 2, wherein the layer 3 signaling is for a configured grant PUSCH.

8. The baseband processor of claim 1, wherein at least one of the following:
the layer 1 signaling comprises downlink control information (DCI); and
the layer 2 signaling comprises a medium access control (MAC) control element (CE).

9. The baseband processor of claim 1, wherein the operations further comprise:
transmitting, using the transceiver of the UE to the base station, UE capability information indicating whether the UE supports switching among the set of waveforms.

10. The baseband processor of claim 1, wherein the set of waveforms include a discrete Fourier transform spread orthogonal frequency division multiplexing (DFT-S-OFDM) waveform and a cyclic prefix orthogonal frequency division multiplexing (CP-OFDM) waveform.

11. (canceled)

12. The baseband processor of claim 1, wherein the uplink transmission is a dynamic scheduled PUSCH.

13. The baseband processor of claim 12, wherein the set of waveforms include two waveforms and the waveform indication is received via at least one of the following:
a one-bit field in a DCI scheduling the dynamic scheduled PUSCH;
a reinterpreted bit in an existing field of the DCI;
an information element in a time domain resource allocation (TDRA) table of the DCI; and
a MAC CE.

14. The baseband processor of claim 1, wherein the uplink transmission is a Msg3 PUSCH initial transmission and re-transmission.

15. The baseband processor of claim 14, wherein the operations further comprise:
selecting a dedicated physical random access channel (PRACH) preamble in a shared PRACH occasion or separate configured PRACH occasion reserved by the base station, and
transmitting, using the transceiver of the UE to the base station, the selected dedicated PRACH preamble,
wherein a UE capability information indicating whether the UE supports switching among the set of waveforms is implicitly informed to the base station via the dedicated PRACH preamble being detected by the BS.

16. The baseband processor of claim 14, wherein the operations further comprise:
transmitting, using the transceiver of the UE to the base station, a request for switching waveform, based on a comparison measurement result between a reference signal receiving power (RSRP) of downlink communication and a predetermined threshold.

17. The baseband processor of claim 14, wherein the set of waveforms include two waveforms and the waveform indication is received via at least one of the following:
a bit of random access response (RAR) grant message;
a reinterpreted bit in hybrid automatic repeat request (HARQ) process number field; and
a reserved bit in MAC random access response (RAR) control element.

18. The baseband processor of claim 17, wherein the bit of RAR grant message is at least one of the following:
a bit related to a time domain resource allocation (TDRA) table;
a bit of a modulation and coding scheme (MCS) information field;
a bit of a transmission power control (TPC) information field;
a bit of a channel state information (CSI) request information field; and
a bit of a PUSCH frequency resource allocation information field.

19. (canceled)

20. The baseband processor of claim 1, wherein the uplink transmission is a MsgA PUSCH initial transmission and re-transmission.

21. The baseband processor of claim 20, wherein the set of waveforms include two waveforms and the waveform indication is received via at least one of the following:
an information element in a new TDRA table; and
a reinterpreted bit in an existing field of an existing TDRA table of the MsgA PUSCH initial transmission and re-transmission;
an one-bit added from the CSI request field information into the existing TDRA table; and
one reserved bit of fallback MAC RAR control element.

22. The baseband processor of claim 1, wherein the uplink transmission is a configured grant PUSCH.

23. The baseband processor of claim 22, wherein the set of waveforms include two waveforms and the waveform indication is received via at least one of the following:
a one-bit field in a TDRA table of a DCI scheduling the configured grant PUSCH;
a reinterpreted bit in an existing field of the DCI; and
a field in timeDomainResourceAllocation IE of ConfiguredGrantConfig IE.

24-48. (canceled)
